(19) United States
(12) Patent Application Publication
(10) Pub. No.: US 2009/0086485 A1
(43) Pub. Date: Apr. 2, 2009

(54) LED louvers and lighting system

(76) Inventor: Ian Osborn, Littleton, CO (US)

Correspondence Address: Ian Osborn, 5526 South Simms Way, Littleton, CO, 80127, US

(21) Appl. No.: 12/070,509

(22) Filed: Feb. 19, 2008

Related U.S. Application Data
(63) Continuation-in-part of application No. 11/906,009, filed on Sep. 29, 2007.

(51) Int. Cl. F21V 5/08; H05B 41/36; F21V 11/00

(52) U.S. Cl. 362/240; 362/246; 315/294

(57) ABSTRACT

A LED louvers and lighting system is described. The system can utilize interchangeable LED light assemblies placed within LED light modules. The light output from the light modules can be directed and diffused via a selection of louvers. A LED controller can be utilized to allow a user to control the light output intensity from the light modules. The LED controller provides a smooth range of changing brightness levels. The system can be controlled via a wired switch and/or a radio frequency remote control. Additionally, the LED light modules are daisy chainable and can utilize low-voltage wiring for ease of installation.

### CROSS-REFERENCE TO RELATED APPLICATIONS

This application is a continuation-in-part of U.S. patent application Ser. No. 11/906,009, entitled “LED Controller and Lighting System” and filed on Sep. 29, 2007, which is specifically incorporated herein by reference for all that it discloses and teaches.

### TECHNICAL FIELD

The invention relates generally to the lighting industry and more particularly to a LED louvers and lighting system.

### BACKGROUND

Electrical lights have been around for well over 100 years. During that time, many variations and improvements in the technologies utilized to produce light have occurred. One of the most recent developments has been the widespread adoption of Light Emitting Diode (LED) lighting systems as a replacement for older incandescent and fluorescent systems.

In the last twenty years, rapid commercialization of LED technologies has occurred. LED lighting systems can be found in everything from hand-held flashlights to standard floor and desk lamps. In fact, the more powerful LEDs of recent manufacture are even being utilized in large-scale outdoor lighting projects.

Nevertheless, while LED lights have made impressive inroads in many areas of the lighting industry, current LED systems still have a few problems and limitations. One such limitation is the general lack of LED controller systems that provide varying intensity outputs for LED lighting systems. A variety of multi-step systems are available, but the resulting lighting effect is similar to a standard three-way incandescent bulb in that three predefined levels of brightness are apparent rather than a smooth increasing and decreasing of the light output levels.

Another technology that is often utilized in LED systems is called a Pulse Width Modulator (PWM). PWMs are used to control the light output of LEDs. A PWM acts by providing segmented pulses of voltage to a LED, causing a flashing or pulsing effect in the light output of the LED. The pulsing effect causes the human eye to perceive an erratic flashing effect when a PWM is used to dim or brighten LED lights. Thus, a need exists for a LED controller and lighting system that can smoothly increase and decrease LED light output intensities without utilizing apparent brightness steps/levels or causing a pulsing of the LED.

Additional problems with the traditional incandescent approach include: relatively low efficiency, high heat output per lumen of light, large size, difficulty installing and changing bulbs, etc. The ability to easily diffuse and direct light output has been hampered as well since the low efficiency/high heat output and other problems listed above significantly decrease the ease of performing diffusion and direction of light output. Therefore, there is a need for a LED lighting system that is efficient, comparatively cool, and relatively inexpensive and simple to install.

### SUMMARY

Embodiments described and claimed herein address the foregoing problems by providing a LED louvers and lighting system. The system can utilize an LED controller to allow the user to control the output intensity of one or more LED lighting systems. The intensity levels or brightness of the LED lights are not limited to 3, 4 or even 10 levels of light output; instead, the LED controller provides what appears to the human eye as a smooth range of changing brightness levels, depending on the needs of the user. Furthermore, the system does not require expensive rewiring since it can utilize a daisy chain method of connecting multiple LED lights using small, low-voltage wires that do not have to be installed by an electrician. The LED light system can be controlled via a radio frequency remote control unit in order to further simplify the installation process (i.e., a hard-wired control unit does not have to be installed). Because of the small size of the LED lights that are used, their low heat output and simplified wiring, installation of the system is much improved over existing technologies. Additionally, the system can utilize one or more sets of louvers. These louvers fit over the LED lights themselves and work to diffuse and direct the light output from the LEDs. Although LEDs produce far less heat than standard incandescent lights, they do produce some heat and the louvers also help to safely and quickly diffuse the heat output as well.

### BRIEF DESCRIPTION OF THE DRAWINGS

The aforementioned and other features and objects of the present invention and the manner of attaining them will become more apparent and the invention itself will be best understood by reference to the following description of a preferred embodiment and other embodiments taken in conjunction with the accompanying drawings, wherein:

FIG. 1 illustrates a view of an exemplary embodiment of a LED controller and lighting system operating on an alternating current power system.

FIG. 2 illustrates a close-up view of an exemplary embodiment of a LED controller and lighting system operating on an alternating current power system.

FIG. 3 illustrates a close-up view of an exemplary embodiment of a LED controller and lighting system operating on a direct current power system.

FIG. 4 illustrates a view of an exemplary embodiment of a LED controller and lighting system that utilizes a radio frequency module for wireless remote control functionality.

FIG. 5 illustrates a close-up view of an exemplary embodiment of a microchip component of a LED controller and lighting system.

FIG. 6 illustrates a side view of an exemplary embodiment of a LED louvers and lighting system.

FIG. 7 illustrates a view of an exemplary embodiment of a LED louvers and lighting system utilizing a wall-mountable switch.

FIG. 8 illustrates a view of an exemplary embodiment of a LED louvers and lighting system utilizing a radio frequency remote switch.

FIG. 9 illustrates a view of an exemplary embodiment of a microchip controller component of a LED louvers and lighting system.

### DETAILED DESCRIPTION

In one embodiment, a LED controller utilizes United States standard residential alternating current (A/C) as a power source (either 110 volt or 220 volt). In another embodiment, a LED controller utilizes direct current (D/C) as a power source (for example, a 12 volt solar-powered system). Other voltage types and sources are contemplated.

A LED controller can be a component in a LED louvers and lighting system. In one embodiment, a LED controller is used within a LED louvers and lighting system to provide a dimming and brightening function. In such a system, a 12 volt solar system can act as the D/C power source (other voltage types and amounts are contemplated). In another such system, a standard A/C power source is used.

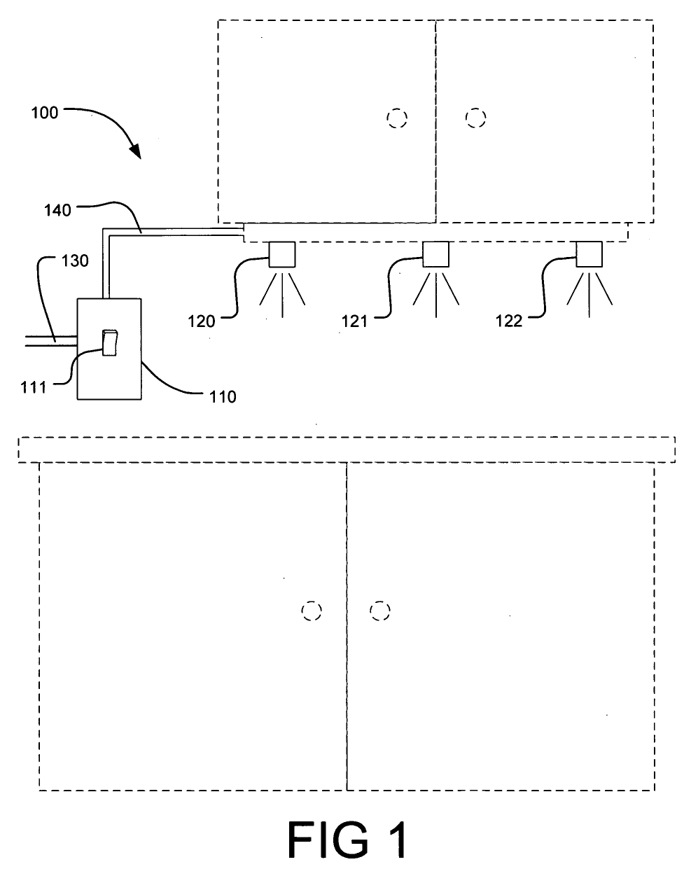

FIG. 1 illustrates an exemplary embodiment of a LED controller and lighting system 100 operating on an A/C power system. The primary components shown in FIG. 1 include: a LED controller 110; a system of LED lights 120, 121, and 122; an A/C power source 130; and the D/C power output 140. The LED controller 110 shown in FIG. 1 is illustrated as a simple switchbox. In other embodiments, other types of switches and/or controls are contemplated. In FIG. 1, the LED controller and lighting system 100 is operating on a standard A/C power source 130. The A/C power source 130 feeds into the LED controller 110. The LED controller 110 contains a number of subcomponents that are not shown in FIG. 1 (see detailed description of the LED controller 110 below). The subcomponents act on the incoming A/C power source 130 and output the D/C power output 140. As shown in FIG. 1, the D/C power output 140 is routed directly to the LED lighting system 120, 121, and 122. However, in alternate embodiments, the D/C power output 140 could connect to other components before being routed to the LED lighting system 120, 121, and 122.

Once the A/C power source 130 is routed to the LED controller 110, a user of the system can operate the rocker switch 111 to control the light output levels of the lighting system 120, 121, and 122. The LED controller 110 is connected to the lighting system 120, 121, and 122 by the D/C power output 140. Because the LED controller 110 does not rely upon a pulse width modulator (PWM) but instead utilizes a custom-coded microchip (among other components) to vary the light intensity of the lighting system 120, 121, and 122, the user will experience a gradual increasing or decreasing of light brightness/intensity while operating the rocker switch 111 instead of a pulsing or flashing effect common to PWM systems.

The lighting system 120, 121, and 122 as shown in FIG. 1 only has 3 LED lights. In other embodiments, the lighting system 120, 121, and 122 can contain fewer lights or more lights than that shown in FIG. 1. Furthermore, the lighting system 120, 121, and 122 can be composed of LED lights having different colors, sizes, shapes, intensities, etc.

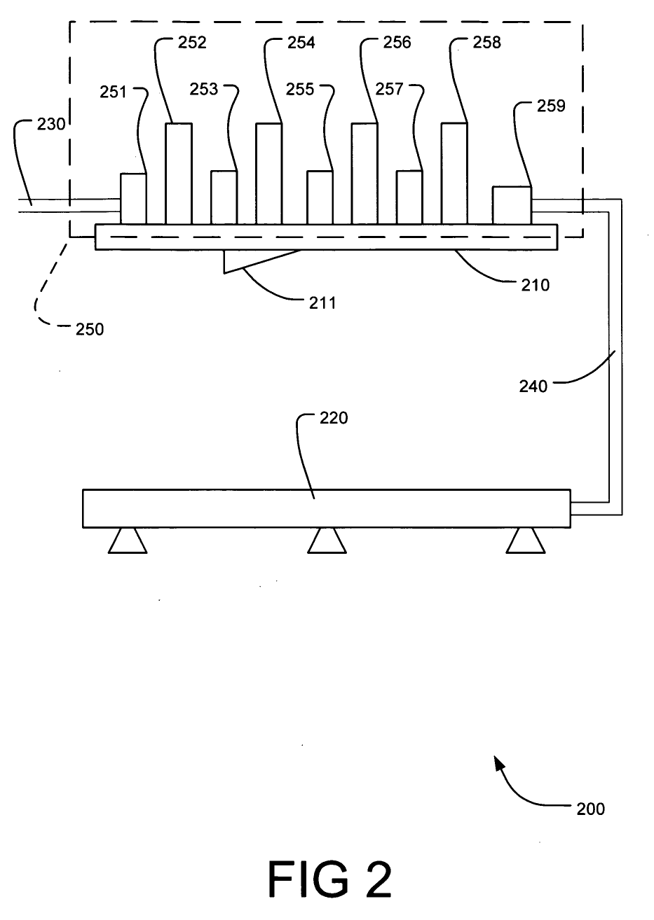

FIG. 2 illustrates a close-up view of an exemplary embodiment of a LED controller and lighting system 200 operating on an A/C power system. In the embodiment in FIG. 2, a switch plate 210 can be used to bring the A/C power from the A/C power source 230 to the terminal blocks 251. The switch plate 210 holds the LED controller 250 in position and the line wires coming from the A/C power source 230 bring the A/C power to the terminal blocks 251 to start the rectification of power to a D/C source. As shown in FIG. 2, the subcomponents of the LED controller 250 are represented by simple rectangles. Furthermore, in alternate embodiments, other subcomponents arranged in similar or different ways are contemplated.

Power is brought in to the LED controller 250 through the terminal blocks 251. The terminal blocks can consist of any components or subcomponents which function as a power input conduit for the LED controller 250. The terminal blocks 251 route power to a bridge rectifier 252. The bridge rectifier 252 transforms the A/C power into a D/C current. The resulting D/C current is then transferred to a capacitor-input filter 253 to smooth the voltage supply. Alternatively, a voltage regulator can be used either instead of or in addition to the capacitor-input filter 253, both to remove the last of the ripple and to deal with variations in supply and load characteristics.

Once the system has access to a D/C current, the power flow must be regulated. In one embodiment, the unregulated D/C power is routed to a capacitor 254 that subsequently produces a supply of relatively clean, uninterrupted D/C power output. Other embodiments may utilize other means or methods of regulating the D/C power. Furthermore, the power could be cleaned and regulated at a completely different location in the circuit, in yet another embodiment. Depending on the specific voltage requirements of other components, an additional voltage regulator 255 could be utilized to bring the exemplary 12 volt D/C current down to a 5 volt D/C current if needed for a 5 volt microchip, for example.

The resulting D/C current is then routed to a microchip 256. In one embodiment, a pre-programmed, static microchip 256 design is used. In another embodiment a re-programmable microchip 256 is used. Regardless of the type of microchip 256 used, its main function is to control the output of the 12 volt signal to the LED lighting system 220 in order to provide dimming and brightening of the LED lighting system 220. This is accomplished by using a programmable code-based microchip 256 that uses an oscillation chip with two hundred and fifty-five or more incremental steps rather than the segmented pulses of a standard PWM. In alternate embodiments, fewer than two hundred and fifty-five incremental steps may be used. In yet another embodiment, more than two hundred and fifty-five incremental steps may be used. Providing incremental steps at a much greater numerical value results in a smooth up and down transition of brightness/intensity of the LED lighting system 220 while maintaining the 12 volt D/C voltage supply. The transition of light output from low intensity to maximum intensity is achieved without the flickering effect of the traditional PWM. The program can be set to dim or intensify in variable increments. Those increments can be either an instantaneous change or a smooth transition without the flickering visual effect. This non-flickering effect is a result of the custom programming of the microchip 256.

In one embodiment, the microchip 256 is programmed to provide a range of brightness from 25% to 75% of the LED lighting system's 220 maximum lumens. In another embodiment, the microchip 256 specifies that on initial power-up, the LED lighting system 220 produces 10% output and then slowly progresses to 100% output over a 30 second period; while a user can halt the progression at any time.

A number of additional capacitors 257 and additional resistors 258 are also utilized throughout the LED controller in order to regulate power, depending upon the desired leg from the microchip 256 and its final function. The additional legs can be used to show and verify that the system has power to a unit (i.e., a LED on the unit showing that the system has power and is functioning). One or more additional LEDs can be used to show if a unit is at fault or has a line short, has crossed wires or a polarity problem, etc. Additional capacitors 257 and additional resistors 258 are utilized to provide the correct power requirements to the LEDs in order to activate them and the corresponding function(s).

In addition to the programmable microchip 256 dimming/brightening functions, the user can also manually affect the dimming/brightening. This is accomplished by operating a rocker switch 211 built into the switch plate 210 described above. The rocker switch 211 sends a signal to the microchip 256 to manually brighten or dim the LED lighting system 220.

The LED controller 250 has a set of outbound terminals 259. The outbound terminals 259 provide the conduit that allows outbound flow of D/C power output 240 from the LED controller 250 to the LED lighting system 220. In the embodiment shown in FIG. 2, the LED lighting system 220 has three LED lights. Other embodiments with a different number of LED lights are contemplated.

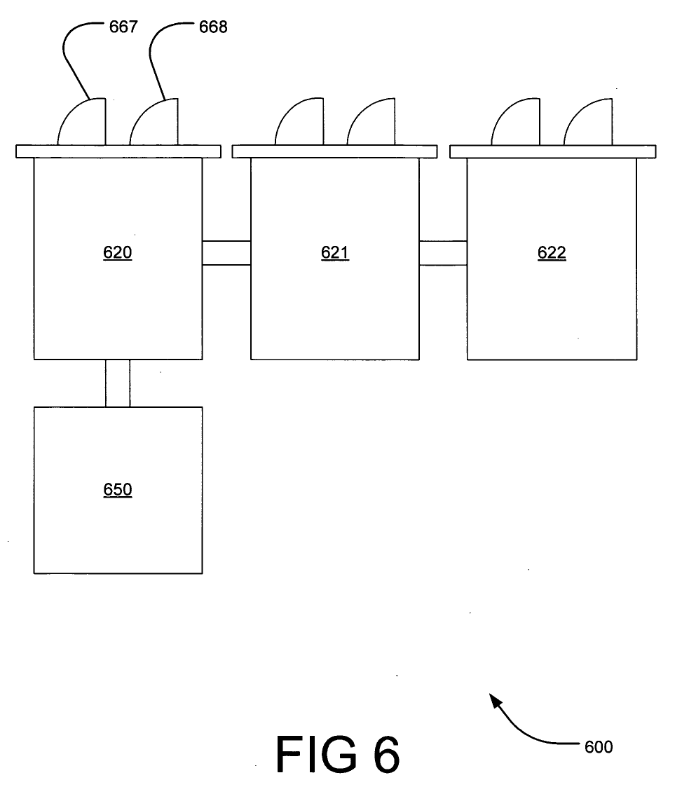

The controller 250 shown in FIG. 2 can be utilized as a controller component in a LED louvers and lighting system (reference the controller 650 component in the detailed description of FIG. 6 below as an example).

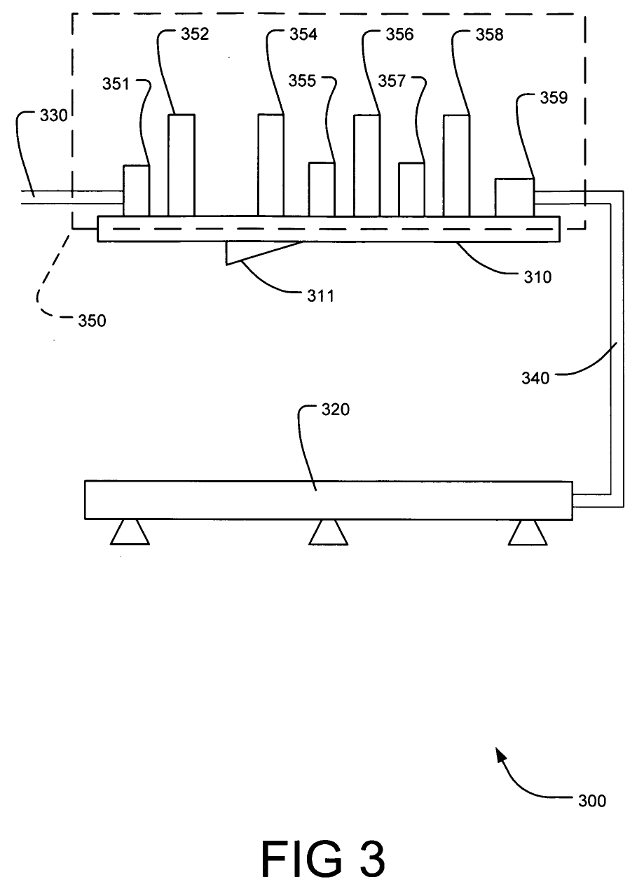

FIG. 3 illustrates a close-up view of an exemplary embodiment of a LED controller and lighting system 300 operating on a D/C power system. In the embodiment in FIG. 3, a switch plate 310 can be used to bring the D/C power from the D/C power source 330 to the terminal blocks 351. The switch plate 310 holds the LED controller 350 in position and the line wires coming from the D/C power source 330 bring the D/C power to the terminal blocks 351. As power is brought in to the LED controller 350 from the terminal blocks 351 it is routed to a voltage regulator 352 to bring the voltage to 12 volts D/C. Other voltages are contemplated.

In one embodiment, the unregulated D/C power is routed to a capacitor 354 that subsequently produces a supply of relatively clean, uninterrupted D/C power output. Other embodiments may utilize other means or methods for regulating the D/C power. Furthermore, the power could be cleaned and regulated at a completely different location in the circuit, in yet another embodiment. Depending on the specific voltage requirements of other components, an additional voltage regulator 355 could be utilized to bring the exemplary 12 volt D/C current down to a 5 volt D/C current if needed for a 5 volt microchip, for example.

The resulting D/C current is then routed to a microchip 356. In one embodiment, a pre-programmed, static microchip 356 design is used. In another embodiment a re-programmable microchip 356 is used. Regardless of the type of microchip 356 used, its main function is to control the output of the 12 volt signal to the LED lighting system 320 in order to provide dimming and brightening of the LED lighting system 320. This is accomplished by using a programmable code-based microchip 356 that uses an oscillation chip with two hundred and fifty-five or more incremental steps rather than the segmented pulses of a standard PWM. In alternate embodiments, fewer than two hundred and fifty-five incremental steps may be used. Providing incremental steps at a much greater numerical value results in a smooth up and down transition of brightness/intensity of the LED lighting system 220 while maintaining the 12 volt D/C voltage supply. The transition of light output from low intensity to maximum intensity is achieved without the flickering effect of the traditional PWM. The program can be set to dim or intensify in variable increments. Those increments can be either an instantaneous change or a smooth transition without the flickering visual effect. This non-flickering effect is a result of the custom programming of the microchip 356.

In one embodiment, the microchip 356 is programmed to provide a range of brightness from 50% to 100% of the LED lighting system's 320 maximum lumens. In another embodiment, the microchip 356 specifies that on initial power-up, the LED lighting system 320 produces 10% output and then slowly progresses to 80% output over a 20 second period; while a user can halt the progression at any time.

A number of additional capacitors 357 and additional resistors 358 are also utilized throughout the LED controller 350 in order to regulate power, depending upon the desired leg from the microchip 356 and its final function. The design of the LED controller 350 and additional legs can be used to attach a remote controlled RF modulator. The RF modulator can then perform the same functions as the rocker switch 311 to dim and/or brighten the lights.

In addition to the programmable microchip 356 dimming/brightening functions, the user can also manually affect the dimming/brightening. This is accomplished by operating a rocker switch 311 built into the switch plate 310 described above. The rocker switch 311 sends a signal to the microchip 356 to manually brighten or dim the LED lighting system 320. The LED controller 350 has a set of outbound terminals 359. The outbound terminals 359 provide the conduit that allows outbound flow of D/C power output 340 from the LED controller 350 to the LED lighting system 320.

The controller 350 shown in FIG. 3 can be utilized as a controller component in a LED louvers and lighting system (reference the controller 650 component in the detailed description of FIG. 6 below as an example).

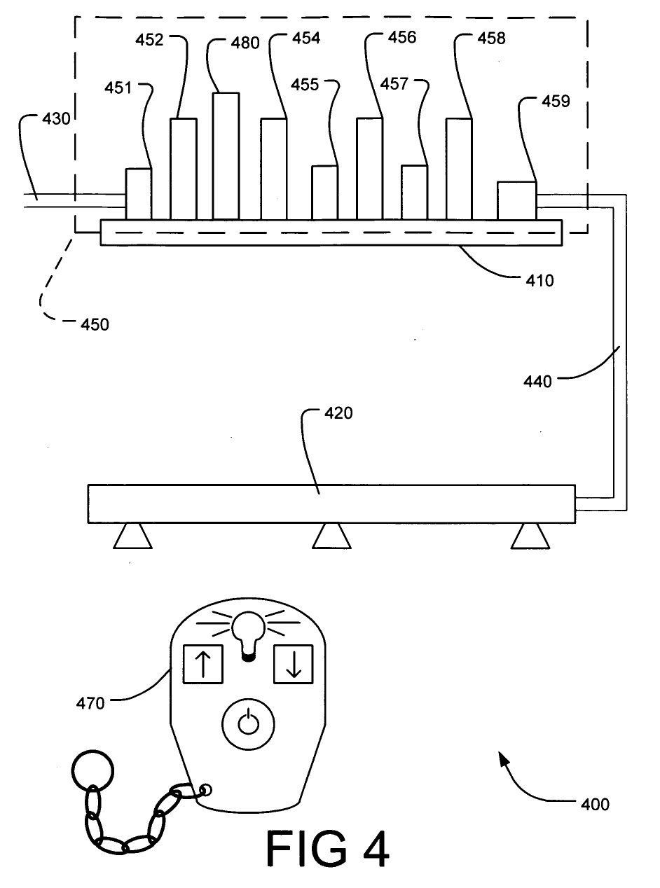

FIG. 4 illustrates a view of an exemplary embodiment of a LED controller and lighting system 400 that utilizes a radio frequency (RF) module 470 for remote control functionality. The LED controller 450 is similar to that shown in FIG. 3 in that it utilizes a D/C power source 430. However, instead of having a manual user control in the form of a rocker switch on the switch plate 410, the embodiment in FIG. 4 utilizes a RF module 470 to allow the user to wirelessly control the brightness/dimming features of the LED controller 450 in order to brighten or dim the LED lighting system 420. As can be seen in FIG. 4, the rocker switch 311 on the switch plate 410 from FIG. 3 has been removed and a RF module 470 with an RF interface 480 to the microchip 456 has been added to the LED controller 450. The remaining LED controller components are similar: the terminal blocks 451, voltage regulator 452, capacitor 454, additional voltage regulator 455, microchip 456, additional capacitors 457, additional resistors 458, and outbound terminals 459. Furthermore, the D/C power output 440 corresponds to that shown in FIG. 3.

The controller 450 shown in FIG. 4 can be utilized as a controller component in a LED louvers and lighting system (reference the controller 650 component in the detailed description of FIG. 6 below as an example).

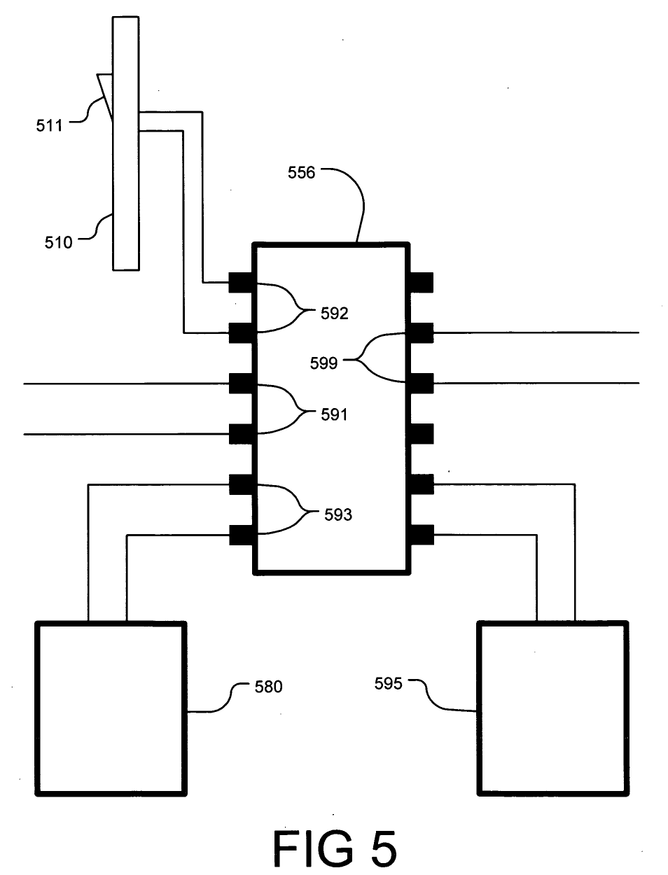

FIG. 5 illustrates a close-up view of an exemplary embodiment of a microchip component 556 of a LED controller and lighting system. As can be seen in FIG. 5, there are a number of inputs and outputs associated with the microchip 556. A set of inputs 591 provides the microchip 556 with its supply of power. A set of outputs 599 can supply the LED lights with power.

In the exemplary embodiment in FIG. 5, the power supply inputs 591 receive 5 volts of clean, regulated D/C power. A second set of inputs, the switch inputs 592, is shown in FIG. 5: they extend from the manual rocker switch 511 in the wall plate 510 to the microchip 556. The rocker switch 511 is triggered manually by the user and signals to the microchip 556 that the LED lighting system should either be dimmed or brightened. In response, the microchip 556 enters a repeating loop process in which the microchip 556 first determines whether the rocker switch 511 is activated. If it is, the microchip 556 then determines the switch state of the rocker switch 511: the switch is set to brighten or the switch is set to dim. In the first case, the microchip 556 increases the intensity level output to the LED lighting system and then enters a programmable-length delay mode before restarting the loop. In the second case, the microchip 556 decreases the intensity level output to the LED lighting system and then enters a programmable-length delay mode before restarting the loop. At the beginning of the loop, the microchip 556 once again determines whether the rocker switch 511 is active or inactive. If active, the loop progresses as above. If inactive, the microchip 556 exits the loop and holds steady the brightness level of the LED lighting system.

In another embodiment, the microchip 556 uses RF inputs 593 to determine the status of the RF interface 580. If the RF interface 580 is active and the rocker switch 511 is active then the microchip 556 enters a programmable-length delay mode before restarting the loop by determining whether the rocker switch 511 and the RF interface 580 are active. If only one of the two is active, the microchip 556 then determines whether the rocker switch 511 or the RF interface 580 is set to brighten or dim. Once that determination is completed, the loop progresses as above: the microchip 556 appropriately modifies the intensity level of the output to the LED lighting system, enters a programmable delay period, and then restarts the loop. If neither of the two is active, the microchip 556 takes no overt action.

In an alternative embodiment, the microchip 556 utilizes a non-volatile memory (NVM) 595 component. The NVM 595 allows the microchip 556 to reset itself to a user-defined or otherwise predetermined brightness/intensity level for the LED lighting system if the power is lost to the LED controller and lighting system.

The microchip 556 shown in FIG. 5 can be utilized within a controller component in a LED louvers and lighting system (reference the controller 650 component in the detailed description of FIG. 6 below as an example).

FIG. 6 illustrates a side view of an exemplary embodiment of a LED louvers and lighting system 600. In the embodiment illustrated in FIG. 6, the primary components of a LED louvers and lighting system 600 that are displayed include: a number of LED light modules 620, 621, and 622; a set of louvers 667 and 668; and a controller 650.

The LED light modules 620, 621, and 622 shown in FIG. 6 can comprise sets of LED lights. For example, LED light module 620 can contain one, two, three, or more individual LED lights. The number of LED light modules 620, 621, and 622 can also vary from that shown in FIG. 6. Systems utilizing one, two, three, four, or even five or more LED light modules 620, 621, and 622 are contemplated. The LED light modules 620, 621, and 622 are daisy chainable. In other words, wiring does not have to be run from the controller to each individual light module; instead, the wiring can run from the controller to the first light module and then each subsequent light module is simply wired to the one before it. This configuration provides for simple and straightforward installations of the LED louvers and lighting system 600.

The controller 650 is shown in FIG. 6 as a simple box. However, the controller 650 can be a complicated component in the system 600; it can contain a number of components and subcomponents as detailed herein (reference the detailed descriptions of the controller components 250, 350, and 450 in FIG. 2, FIG. 3, and FIG. 4, respectively, above). In the alternative, a simple controller can function similarly to an on/off switch. A primary controller function is to control the system 600. It accepts input power in the form of electricity from a power source, acts upon the electricity, and uses it to power the LED light modules 620, 621, and 622.

The louvers 667 and 668 illustrated in FIG. 6 are shown from a side view. Each of the LED light modules 620, 621, and 622 are shown with louvers. However, the number of louvers on each light module can vary from that shown in FIG. 6. Furthermore, LED light modules may be added to the system without utilizing louvers of any kind. The louvers 667 and 668 on LED light module 620 are shown as a quarter-circle shape and are facing the same direction. In alternate embodiments, other shapes and styles of louvers 667 and 668 are contemplated as are alternate orientations. The shape and orientation of the louvers can be selected based on their light and heat diffusing and directing characteristics and their aesthetics in regard to their installation location.

As noted above, the individual LED light modules 620, 621, and 622 can each contain any number of LED lights. The LED lights can be formed into strips of lights on a flat, rectangular shaped board. A board containing a number of LED lights can be termed a LED light assembly. The assembly can then snap into the light modules 620, 621 and 622. An individual light module 620 can have a number of small bumps or protrusions on its interior surface so as to allow an assembly of LED lights to snap in place between and be held by the bumps within the light module 620.

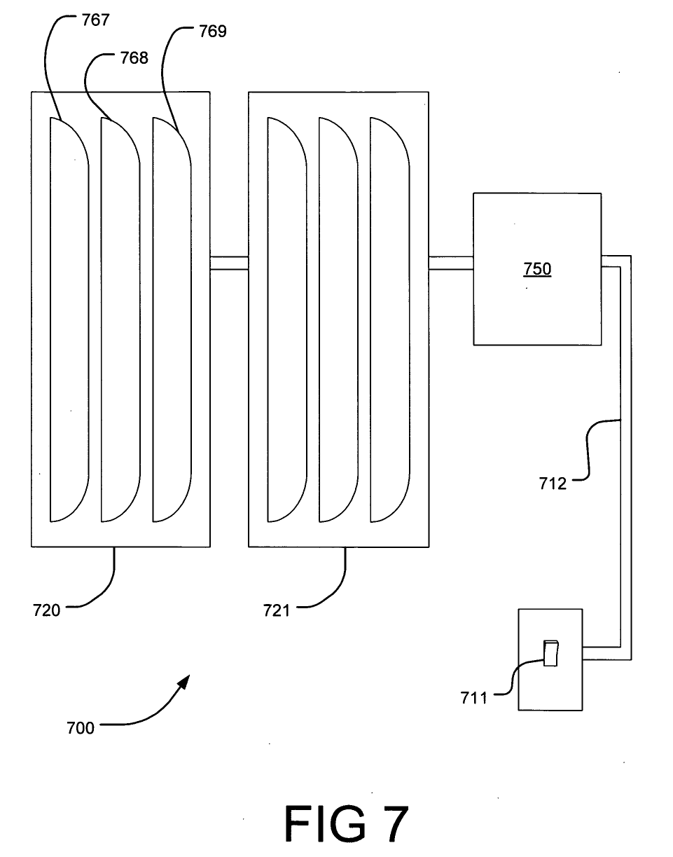

FIG. 7 illustrates a view of an exemplary embodiment of a LED louvers and lighting system 700 utilizing a wall-mountable switch 711. A LED louvers and lighting system 700 is shown with two LED light modules 720 and 721. In alternate embodiments the number of LED light modules may be less than or greater than that illustrated in FIG. 7. The LED light modules 720 and 721 are daisy chainable. This configuration provides for simple and straightforward installations of the LED louvers and lighting system 700.

The LED light modules 720 and 721 are shown in FIG. 7 from a top view. The louvers 767, 768, and 769 are oriented to run the length of the module 720. Alternate configurations are contemplated, such as with the louvers 767, 768, and 769 running the width of the module 720. The number, size, shape, and orientation of the louvers can vary without departing from the scope of the invention.

As illustrated in FIG. 7, the wall-mountable switch 711 can be used by a person to control the system. In the embodiment shown in FIG. 7, the switch 711 is mounted on a wall. Other locations, types, and styles of switches are contemplated in alternate embodiments. The switch 711 can be a simple on/off switch as shown in FIG. 7, or it can be a more complicated switching device. In one embodiment, the switch 711 could have a dimming capability. In yet another embodiment, the switch 711 could incorporate a timer to automatically control the LED light modules 720 and 721. Yet more switching alternatives are contemplated, including, but not limited to: switches that control each individual LED light module separately; switches that respond to user voice commands; switches that store, recall, and initiate user-lighting patterns; switches that are aware of available power and user lighting requirements and automatically adjust to compensate for various levels of available power; etc.

The wall-mountable switch 711 shown in FIG. 7 utilizes a wire 712 that attaches it to the controller 750 in order to communicate user commands. In an alternate embodiment, the switch 711 functions wirelessly.

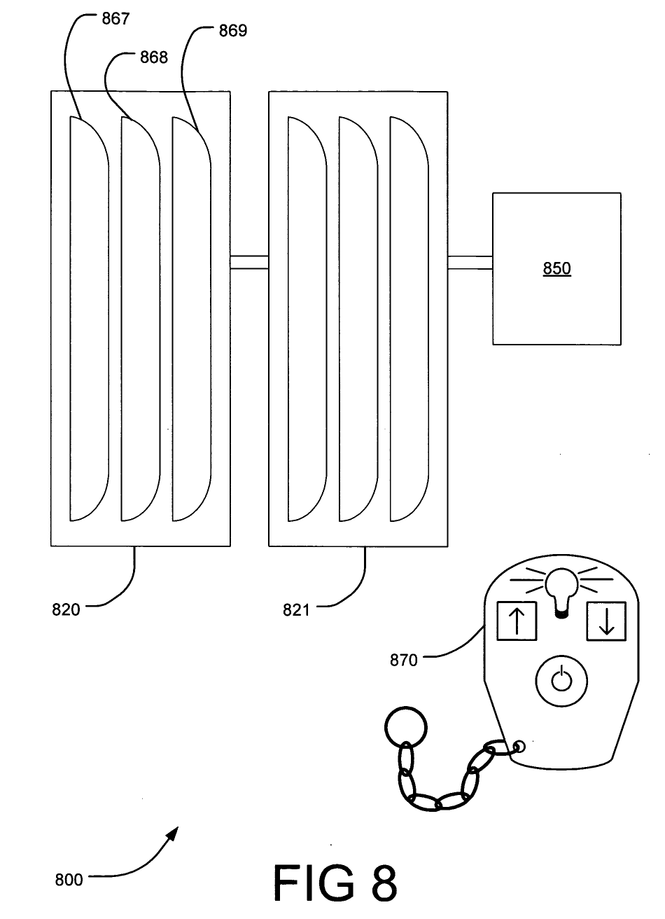

FIG. 8 illustrates a view of an exemplary embodiment of a LED louvers and lighting system 800 utilizing a radio frequency remote switch 870. As illustrated in FIG. 8, the remote switch 870 can be used by a person to control the system 800. The remote switch 870, as shown in FIG. 8, can function as an on/off switch with brightening and dimming capabilities. In an alternate embodiment, the remote switch 870 has only on/off functionality. In yet another embodiment, the remote switch 870 can be a more complicated switching device. For example, a remote switch 870 could incorporate a timer to automatically control the LED light modules 820 and 821. Yet more remote switching alternatives are contemplated, including, but not limited to: remote switches that control each individual LED light module separately; remote switches that respond to user voice commands; remote switches that store, recall, and initiate user-lighting patterns; remote switches that are aware of available power and user lighting requirements and automatically adjust to compensate for various levels of available power; etc.

In addition, LED louvers and lighting systems 800 are contemplated that incorporate both a wall-mountable switch 711 (see FIG. 7) and a remote switch 870. As shown in FIG. 8, the remote switch 870 is a keychain-style remote. In other embodiments, other sizes, styles and types of switches are contemplated.

A LED louvers and lighting system 800 is illustrated with LED light modules 820 and 821 displayed from a top view. The louvers 867, 868, and 869 are oriented to run the length of the module 820. Alternate configurations are contemplated, such as with the louvers 867, 868, and 869 running the width of the module 820. The number, size, shape, and orientation of the louvers can vary without departing from the scope of the invention. The LED light modules 820 and 821 are daisy chainable. This configuration provides for simple and straightforward installations of the LED louvers and lighting system 800.

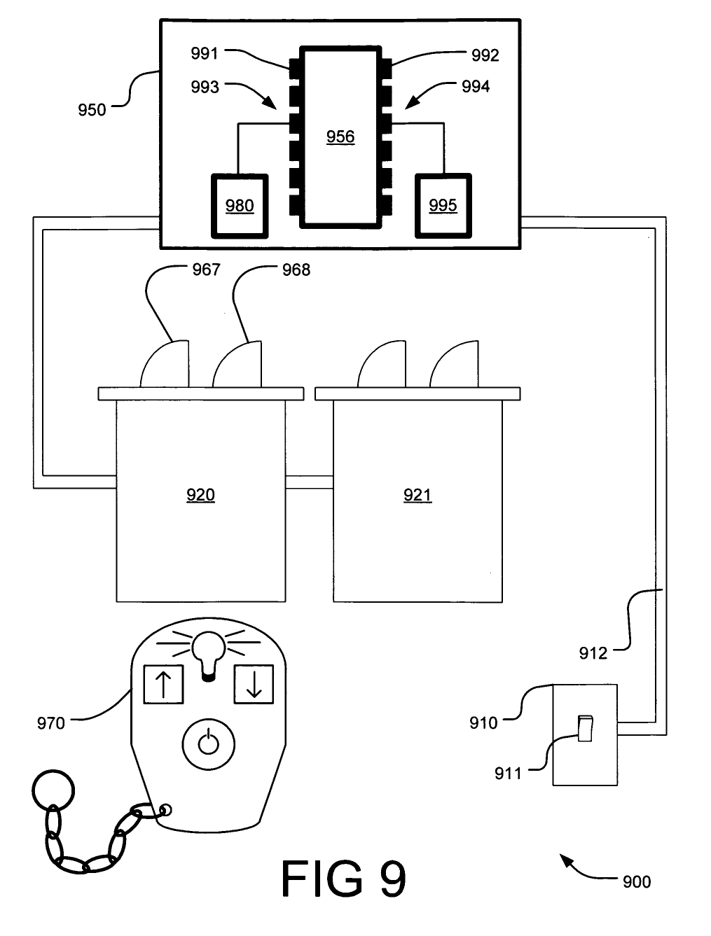

FIG. 9 illustrates a view of an exemplary embodiment of a microchip controller component 956 of a LED louvers and lighting system 900. There are a number of primary components shown in FIG. 9, including: the switch 911, controller 950, microchip 956, LED light modules 920 and 921, and the RF remote switch 970. The microchip 956 is one component of the controller 950. See above for details of other controller 950 components.

The number, shape, orientation and size of the LED light modules 920 and 921 as well as the louvers 967 and 968 can vary considerably from the embodiment shown in FIG. 9 in order to meet the lighting needs of the installation, for aesthetic appearance, etc., without departing from the scope of the invention. The LED light modules 920 and 921 are daisy chainable. This configuration provides for simple and straightforward installations of the LED louvers and lighting system 900.

As can be seen in FIG. 9, there are a number of inputs and outputs associated with the microchip 956. One input, the power supply input 991, provides the microchip 956 with its supply of power. In the exemplary embodiment in FIG. 9, the power supply input 991 receives five volts of clean, regulated D/C power. Other voltages and types of power are contemplated. A second input, the switch input 992, is shown in FIG. 9: it extends from the switch 911 in the wall plate 910 to the microchip 956 via a wire 912. The switch 911 is triggered manually by a user and signals to the microchip 956 that the LED louvers and lighting system 900 should either be dimmed or brightened. In other embodiments, the switch 911 sends much more complicated and actionable information to the microchip 956, either via a wire 912 or wirelessly or a combination thereof. In response, the microchip 956 enters a repeating loop process in which the microchip 956 first determines whether the switch 911 is activated. If it is, the microchip 956 then determines the switch state of the switch 911: the switch state is set to brighten or the switch state is set to dim. In the first case, the microchip 956 increases the intensity level of the light output by the system 900 and then enters a programmable-length delay mode before restarting the loop. In the second case, the microchip 956 decreases the intensity level of the light output by the system 900 and then enters a programmable-length delay mode before restarting the loop. At the beginning of the loop, the microchip 956 once again determines whether the switch 911 is active or inactive. If active, the loop progresses as above. If inactive, the microchip 956 exits the loop and holds steady the brightness level of the system 900.

In another embodiment, the microchip 956 uses RF inputs 993 to determine the status of the RF interface 980. The RF interface 980 receives input signals from the RF remote switch 970. These input signals tell the RF interface 980 what status to report. If the RF interface 980 has an active status and the switch 911 is also active then the microchip 956 enters a programmable-length delay mode before restarting the loop and again determining whether the switch 911 and the RF interface 980 are active. If only one of the two is active, the microchip 956 then determines whether the switch 911 or the RF interface 980 is set to brighten or dim. Once that determination is completed, the loop progresses as above: the microchip 956 appropriately modifies the intensity level of the output of the LED light modules 920 and 921, enters a programmable delay period, and then restarts the loop. If neither the switch 911 nor the RF interface 980 is active, the microchip 956 takes no overt action.

In an alternative embodiment, the microchip 956 utilizes a non-volatile memory (NVM) interface 994 to receive signals from a NVM component 995. The NVM 995 allows the microchip 956 to reset itself to a user-defined or otherwise predetermined brightness/intensity level for the LED light modules 920 and 921 if the power is lost to the LED louvers and lighting system 900. The NVM can store additional defaults or user-specified information that can be used by the system 900.

In yet other embodiments, the microchip 956 receives other inputs and incorporates them into in its decision process in order to determine appropriate output commands that it should give. Additionally, the microchip 956 could have other outputs as well.

The above specification, examples and data provide a description of the structure and use of exemplary embodiments of the described articles of manufacture and methods. Many embodiments can be made without departing from the spirit and scope of the invention.

What is claimed is:

1. A LED louvers and lighting system, comprising:
a plurality of LED light modules wherein each LED light module contains a plurality of LED light assemblies;
a LED controller connected to the plurality of light modules and having at least one microchip; and
a plurality of louvers placed in proximity to the plurality of LED light modules such that the plurality of louvers serve to diffuse and direct light emitted from the plurality of LED light modules.

2. The LED louvers and lighting system of claim 1, wherein the LED controller has a plurality of terminal blocks and the terminal blocks accept an input power from a power source.

3. The LED louvers and lighting system of claim 2, wherein the terminal blocks transfer the input power to a bridge rectifier;
the bridge rectifier transforms the input power to a direct current;
the bridge rectifier transfers the direct current to a capacitor; and
the capacitor transfers the direct current to the microchip.

4. The LED louvers and lighting system of claim 2, wherein the terminal blacks transfer the input power to a voltage regulator;
the voltage regulator regulates the input power to a predetermined voltage; and
the voltage regulator transfers the regulated input power to the microchip.

5. The LED louvers and lighting system of claim 3, wherein the microchip is a programmable code-based microchip utilizing an oscillation chip with a plurality of incremental steps.

6. The LED louvers and lighting system of claim 4, wherein the microchip is a programmable code-based microchip utilizing an oscillation chip with a plurality of incremental steps.

7. The LED louvers and lighting system of claim 1, wherein the plurality of LED light modules are daisy chainable.

8. A LED louvers and lighting system, comprising:
a power source;
a plurality of LED light modules;
a LED controller connected to the plurality of light modules and to the power source, wherein the controller has at least one microchip; and
a plurality of louvers placed in proximity to the plurality of LED light modules such that the plurality of louvers serves to diffuse and direct light emitted from the plurality of LED light modules.

9. The LED louvers and lighting system of claim 8, further comprising:
a plurality of LED light assemblies wherein at least one selected LED light assembly is fitted within at least one selected LED light module by placing the selected LED light assembly between a plurality of protrusions on an inside surface of the selected LED light module.

10. The LED louvers and lighting system of claim 8, wherein a means of controlling the microchip is a switch which allows a user to at least smoothly brighten or dim the plurality of LED light modules.

11. The LED louvers and lighting system of claim 8, wherein a means of controlling the microchip is a radio frequency remote switch which allows a user to at least turn on and off the plurality of LED light modules.

12. The LED louvers and lighting system of claim 8, wherein the microchip utilizes non-volatile memory.

13. The LED louvers and lighting system of claim 9, wherein the microchip utilizes non-volatile memory.

14. The LED louvers and lighting system of claim 9, wherein the microchip is a programmable code-based microchip utilizing an oscillation chip with a plurality of incremental steps.

15. The LED louvers and lighting system of claim 8, wherein the plurality of LED light modules are daisy chainable.

16. The LED louvers and lighting system of claim 9, wherein the plurality of LED light modules are daisy chainable.

17. The LED louvers and lighting system of claim 14, wherein the plurality of LED light modules are daisy chainable.

18. A method of installing a LED louvers and lighting system wherein the system has a plurality of LED light modules, a plurality of LED light assemblies, and a plurality of louvers, comprising:
selecting a LED light module from the plurality of LED light modules;
selecting a LED light assembly from the plurality of LED light assemblies;
placing the selected LED light assembly within the selected LED light module;
snapping the assembly into a space between a plurality of protrusions on an inside surface of the LED light module;
selecting a louver from the plurality of louvers;
attaching the louver to the LED light module to form a LED lighting unit;
plugging the LED lighting unit into a controller;
daisy chaining the LED lighting unit to a plurality of other LED lighting units; and
mounting the LED lighting units and the controller in an installation location.

19. The method of claim 18, wherein the LED controller has a microchip.

20. The method of claim 19, wherein the microchip is a programmable, code-based microchip utilizing an oscillation chip with a plurality of incremental steps.
